(19) United States
(12) Patent Application Publication
(10) Pub. No.: US 2011/0108523 A1
(43) Pub. Date: May 12, 2011

(54) Method for Fabrication of Microparticles with Colloidal Particle-Anchored Surface Structures

(75) Inventors: Seung-Man Yang, Daejeon (KR); Shin-Hyun Kim, Daejeon (KR); Hyerim Hwang, Daejeon (KR); Jae Won Shim, Daejeon (KR); Gi-Ra Yi, Chungbuk (KR)

(73) Assignee: KOREA ADVANCED INSTITUTE OF SCIENCE AND TECHNOLOGY, Daejeon (KR)

(21) Appl. No.: 12/838,699

(22) Filed: Jul. 19, 2010

(30) Foreign Application Priority Data
Nov. 9, 2009 (KR) 2009-0107754

(51) Int. Cl. B29B 9/16; C08K 3/22; C08K 3/20; C08J 3/28; C08K 3/04; C08J 9/26

(52) U.S. Cl. 216/56; 522/81; 522/83; 522/111; 522/153; 522/152; 522/170; 522/173; 522/71; 521/50.5; 977/774; 977/902

(57) ABSTRACT

A method for fabrication of microparticles using a photo-polymerizable colloidal dispersant is provided. The method includes (a) preparing liquid droplets in a continuous phase from photo-polymerizable resin containing colloidal particles dispersed therein, then, allowing the colloidal particles to move toward an interface of the liquid droplets; and (b) UV exposing the liquid droplets to enable photo-polymerization thereof, so as to produce microparticles having a structure formed of colloidal particles on a surface of the microparticles. In addition, in order to improve the surface structure and characteristics, the foregoing method further includes (c) selective chemical reaction of the colloidal particles formed on the surface of the microparticles or, otherwise, removal of the colloidal particles.

### CROSS-REFERENCE TO RELATED APPLICATIONS

This application claims priority to foreign Patent Application KR 2009-0107754, filed on Nov. 9, 2009, the disclosure of which is incorporated herein by reference in its entirety.

### FIELD OF THE INVENTION

The present invention relates to a method for fabrication of microparticles with a nano- or micro-sized surface structure using polymerizable liquid droplets (often referred to as “droplets”) filled with colloidal particles at an interface of the droplets and, more particularly, to a method for fabrication of microparticles with a colloidal particle-anchored surface structure, including: dispersing colloidal particles in a polymerizable resin; forming the prepared dispersion into liquid droplets and enabling movement of the colloidal particles toward an interface of the droplets; and photo-polymerizing the droplets in order to form a colloidal particle-anchored surface structure, thus producing microparticles having such a surface structure. In addition, the present invention relates to a method for fabrication of microparticles with different surface structures by optionally conducting chemical reaction on colloidal particles formed on the surface or removal of particles.

### BACKGROUND OF THE INVENTION

Conventional methods for fabrication of microparticles using liquid droplets are generally performed by liquid condensation based on a vaporization process. These methods adopt a process of preparing droplets in a continuous phase from a solution containing a polymer substance or colloidal particles dispersed therein and evaporating the droplets, so as to prepare micro-spherical agglomerates. When water containing silica nanoparticles dispersed therein is formed into droplets with a regular size in an oil phase and the droplets are evaporated, micro-spherical silica microparticles dispersed in the oil phase are obtained. Using titania nanoparticles by the same process, spherical titania microparticles are obtained. When a toluene solution containing polystyrene is formed into droplets dispersed in water and the droplets are evaporated, polystyrene microparticles are obtained. However, since the foregoing methods employ a vaporization process, particle fabrication speed is low and complicated processing conditions are required, although microparticles may be easily prepared using a variety of substances. In addition, the above methods have difficulties in formation of desired surface structures.

Polymer spherical microparticles have been fabricated by forming uniform-sized droplets from a photo-polymerizable resin in water containing a surfactant dispersed therein using a micro-fluidic device, and photo-polymerizing the prepared droplets. Especially, using a channel of the micro-fluidic device, a shape of liquid droplets was varied into, for example, a disk type, a rod type, etc. As a result, the microparticles may be fabricated in different forms. However, since an interface of droplets is changed into a surface of the microparticles by photo-polymerization, the microparticles may have a smooth surface alone.

According to one known process, a surface structure based on colloidal particles was formed by adsorbing colloidal particles from a continuous phase to an interface of photo-polymerizable droplets, and photo-polymerizing the adsorbed droplets. However, this process has drawbacks such as excessive consumption of colloids and difficulties in preparation of microparticles having a regular size.

Among conventional technologies for fabrication of microparticles using droplets, a process of preparing spherical agglomerates by evaporation of droplets entails disadvantages such as long production time, complicated processing conditions, and difficulties in formation of a surface structure. Alternatively, use of photo-polymerizable droplets without colloids was recently disclosed, however, has a problem such as impossible formation of a surface structure. Another method for preparation of microparticles with a surface structure using photo-polymerizable droplets by adsorbing colloidal particles from a continuous phase to an interface of the droplets also encounters problems such as consumption of excessive colloids and difficulties in preparation of microparticles having a regular size.

### SUMMARY OF THE INVENTION

Embodiments of the present invention advantageously provide a method for mass-production of microparticles having a surface structure under simple and speedy processing conditions. In particular, uniform control of a size of microparticle and improvement in surface structure and characteristics thereof are advantageously provided.

Embodiments of the present invention also provide a method for fabrication of microparticles by moving colloidal particles dispersed in droplets toward an interface of the droplets and enabling the colloidal particles to remain on the same. Here, using photo-polymerizable droplets, solidification may be simply and rapidly progressed. Since colloids dispersed in the droplets are used, microparticles having a surface structure may be efficiently prepared without over-consumption. In particular, functional groups of the colloidal particles present on a surface of microparticles may be used for further chemical reaction, so as to provide various functionalities. When the colloidal particles are selectively removed, porous microparticles having holes on a surface thereof may be fabricated.

One embodiment of the present invention provides a process for fabrication of microparticles having a surface structure, including: (a) preparing droplets in a continuous phase from photo-polymerizable resin containing colloidal particles dispersed therein; (b) UV exposing the prepared droplets to obtain microparticles; and (c) optionally, subjecting the prepared microparticles to further chemical reaction so as to improve a surface structure and characteristics thereof.

Use of photo-polymerizable resin advantageously overcomes conventional techniques for production of microparticles by evaporation of droplets, enabling considerable decrease in processing time and simplification of processing conditions. In particular, by introducing colloidal particles into the photo-polymerizable droplets, waste of the colloidal particles is prevented. In addition, microparticles having excellent uniformity in size were produced. The obtained microparticles may be subjected to further chemical processes to form specific microparticles having improved functionality. Such microparticles having a surface structure fabricated according to the present invention may be employed in a wide range of applications.

First, owing to a structure of protrusions present on a surface of the microparticles, these particles exhibit high fluidity substantially similar to that of liquid powder and easily endow electrical and optical characteristics to the same, in turn embodying excellent availability as particles for electronic paper. In addition, a chemical reaction capable of selectively forming a metallic substance only above the colloidal particles, which are present on a surface of microparticles may be carried out, thus fabricating microparticles having a patterned metal nano-structure. The fabricated microparticles can be used for a high sensitivity sensor to detect chemicals and/or bio-materials. If colloids present on a surface of the microparticles are selectively removed, porous microparticles having holes on a surface thereof may be produced. Especially, reactive ion etching may improve porosity and introduction of hydrophobic chemical substances may enable production of super-hydrophobic microparticles. Such produced microparticles can be employed in various applications including, for example, formation of a super-hydrophobic surface.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating a process for fabrication of microparticles having a surface structure according to an embodiment of the present invention;

FIG. 2 is an SEM photograph showing microparticles having a smooth surface prepared in Example 1;

FIG. 3 is another SEM photograph showing microparticles having an irregular size and a surface structure formed using silica particles prepared in Example 1;

FIG. 4 is another SEM photograph showing porous microparticles having an irregular size and holes on a surface of the microparticles prepared in Example 1;

FIG. 5 is each an optical microphotograph and SEM photograph showing microparticles having a regular size prepared in Example 2;

FIG. 6 is each SEM photographs showing microparticles with a surface structure formed by silica particles having different sizes and microparticles with a surface structure formed of different-sized holes, prepared in Example 3;

FIG. 7 is a confocal micrograph showing microparticles containing different dyes inside and a surface thereof, prepared in Example 4;

FIG. 8 is each an optical micrograph and SEM photograph showing microparticles with a patterned Ag nano-structure and a surface thereof, respectively, prepared in Example 6;

FIG. 9 is an optical micrograph showing microparticles containing iron oxide nanoparticles, prepared in Example 7;

FIG. 10 is an SEM photograph showing porous microparticles with a hexagonal arrangement of holes on a surface thereof, prepared in Example 8; and

FIG. 11 is an SEM photograph showing microparticles having a super-hydrophobic surface, prepared in Example 8.

### DETAILED DESCRIPTION

Hereinafter, various embodiments of the present invention will be described in more detail through the following examples, in conjunction with accompanying drawings.

According to an exemplary embodiment of the present invention, there is provided a method for fabrication of microparticles having a surface structure, which includes: (a) preparing droplets in a continuous phase from photo-polymerizable resin containing colloidal particles dispersed therein; (b) photo-polymerizing the prepared droplets to produce microparticles; and (c) optionally, subjecting the prepared microparticles to further chemical reaction so as to improve functionality thereof.

Such a photo-polymerizable resin may be prepared using a substancecapable of forming droplets in a continuous phase. Examples of the photo-polymerizable resin may include a monomer solution having an acrylate, cyanoacrylate or epoxy group, a monomer solution having a urethane group, and the like. ETPTA is a monomer containing an acrylate group.

A size of the liquid droplets ranges from several micrometers to several millimeters.

The droplets may comprise 1 to 10% (v/v) colloidal particles such as silica, titania, polystyrene, etc. in order to form a surface structure. If a content of the colloids is less than 1%, a surface of the droplets may not be full of colloids. On the other hand, when the content of colloids exceeds 10%, the droplets contain a larger amount of colloids inside than the surface thereof, thus causing waste of particles.

Additionally, the droplets may include 0.01 to 10% (v/v) of quantum dots, metal nanoparticles, iron oxide nanoparticles, carbon black nanoparticles, titania nanoparticles, etc. When titania is treated to remain on the surface of droplets, this material may help formation of a surface structure. Also, titania may function as a scattering material by inducing the same to remain inside the droplets.

Chemical substances such as dye molecules and chemical pigments may be added to the droplets. By adding a dye to the droplets, microparticles with fluorescence may be obtained. Such a dye may include, for example, rhodamine, fluorescein and/or coumarin based dyes. If a chemical pigment (synthetic coloring agent) is introduced into the droplets, colored microparticles may be produced. Food dyes such as Green No. 1, Red No. 1, etc. are representative of typically available coloring agents.

In the foregoing description, a dye introduced into the droplets prepared in Step (a) has substantially similar functions to those of another dye combined with colloidal particles on a surface of microparticles in Step (c), and both the dyes are used to prepare fluorescent particles. More particularly, the dye used in Step (a) generates fluorescent signals in the entirety of an inner space of the prepared microparticles whilst the other dye used in Step (c) outputs fluorescent signals from a surface of microparticles. The available dyes are substantially the same between Step (a) and (c), and may include rhodamine, fluorescein and/or coumarin based dyes.

One embodiment of the present invention provides a method for fabrication of microparticles having a surface structure, comprising: (a) preparing droplets in a continuous phase from photo-polymerizable resin containing colloidal particles dispersed therein; (b) UV exposing the prepared droplets to form microparticles; and (c) optionally, subjecting the obtained microparticles to further processing so as to improve the surface structure.

The photo-polymerizable resin used in Step (a) may be at least one or two selected from a group consisting of photo-polymerizable monomers having acrylate groups such as ethoxylated trimethylol propane triacrylate (ETPTA, MW 428, viscosity 60 cps), although duly not restricted thereto so long as it is a UV curable monomer.

The continuous phase in Step (a) is not particularly limited so long as it comprises a solvent capable of forming droplets from photo-polymerizable resin. Herein, the continuous phase may contain a surfactant for stabilization of droplets. When using ETPTA resin, the continuous phase may be 1% Pluronic F108 (Ethylene Oxide/Propylene Oxide/Ethylene OXIDE Triblock Copolymer, BASF) dispersed in water.

The photo-polymerizable resin used in Step (a) may further include 1 to 10% (v/v) colloidal particles such as silica, titania, polystyrene, etc. A size of each colloidal particle may range from 10 to 10,000 nm.

If the size of the colloidal particle for formation of a surface structure is less than 10 nm, even particles present at the interface of droplets are easily removed from the interface by thermal energy, causing difficulties in use of uniform surface structure. The colloidal particle should be smaller than a microparticle and, preferably, has a size of 10,000 nm.

The photo-polymerizable resin in Step (a) may further include 0.01 to 10% (v/v) nanoparticles such as quantum dots, metal nanoparticles, iron oxide nanoparticles, carbon black nanoparticles, titania nanoparticles, and the like. Herein, a size of the nanoparticle may range from 1 to 100 nm. In addition, the resin may further contain a chemical substance such as dye molecules and chemical pigments. 1 nm nanoparticle is a minimum size while 100 nm is about 100 nm in order to form quantum dots and nanoparticles.

As to formation of droplets in Step (a), emulsification using a micro-fluidic device, use of a shaker, a vortex mixer and/or a homogenizer, etc. may be employed, although not particularly limited thereto so long as droplets can be formed.

Photo-polymerization in Step (b) may be performed by UV curing at a light intensity of 40 mW/cm² for 0.1 to 10 seconds, however, any combination of desired light intensity and time capable of completely photo-curing resin droplets may be applied.

An additional process in Step (c) may include various chemical reactions. Such a chemical reaction is carried out in only an exposure region of colloidal particles present on a surface of microparticles in order to enable patterning of a specific chemical substance on the surface of the microparticles. For instance, when silica particles are present on the surface of microparticles, the silica particles may only be combined with dye molecules or hydrophobic molecules through silanol groups bonded to a surface of silica. Silver mirror reaction may enable selective formation of a silver nano-structure on the surface of silica particles. If particles present on the surface of microparticles are selectively eliminated, porous microparticles having holes on the surface thereof may be produced. In particular, an additional chemical reaction may occur according to desired methods such as reactive ion etching, thus easily modifying surface characteristics of the microparticles.

Embodiments of the present invention provide a method for fabrication of microparticles with a surface structure using photo-polymerizable droplets containing colloidal particles.

According to conventional techniques, formation of microparticles having a surface nano-structure was substantially impossible even using photo-polymerizable droplets. According to these methods, microparticles having a smooth surface only were provided. Although a process for fabrication of microparticles having a colloidal structure on a surface thereof using colloidal particles from a continuous phase has been proposed, this process entails problems such as excessive consumption of colloidal particles and difficulties in size control of microparticles.

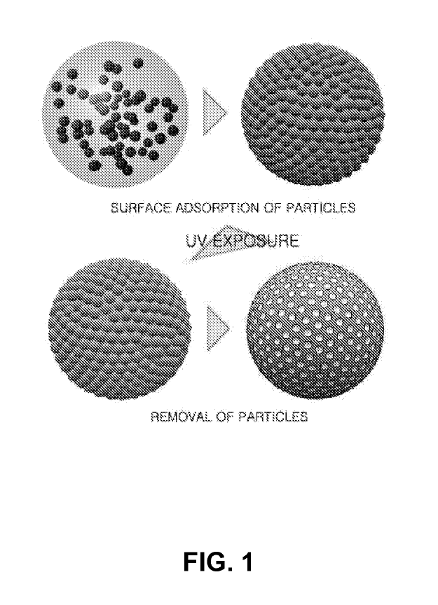

However, a method for fabrication of microparticles according to an embodiment of the present invention is characterized in that microparticles having a surface structure are produced by movement of colloidal particles toward an interface of droplets and residence of the colloidal particles thereon for a long period and, therefore, may have advantages such as decreased consumption of colloidal particles, formation of microparticles with excellent uniformity in size, etc. An additional chemical process may be applied to remove the colloidal particles present on a surface or conduct patterning of the same with a chemical substance and/or a metal nano-material. FIG. 1 is a schematic view illustrating a process of fabricating microparticles according to an embodiment of the present invention.

Colloidal particles contained in photo-polymerizable droplets may move toward an interface of the droplets and remain on the same. Such a behavior is determined according to relative interfacial affinity between the droplets and a continuous phase owing to surface characteristics of the colloidal particles. Compared to the colloidal particles present in a continuous phase or on the interface of droplets, if the colloidal particles existing in the droplets have lower overall interfacial energy, the colloidal particles are generally present inside the droplets. On the other hand, if interfacial energy is decreased in case that the colloidal particles remain on the interface, the colloidal particles shift toward the interface and continuously remain on the same for a long time. Here, the interfacial energy reduction per single particle anchoring on the interface E_{b} is relates to a contact angle θ and a radius of particle R, which is described by the following Equation 1:

E_{b}=πR²γ_{ow}(1−cos θ)² (Equation 1)

In Equation 1, γ_{ow} refers to interfacial tension and this equation is available when a size of droplet is larger 10 times a size of particle.

By adjusting surface characteristics of colloidal particles, the colloidal particles may move toward an interface of droplets and remain on the same or, otherwise, be present inside the droplets.

The photo-polymerizable resin was ethoxylated trimethylolpropane triacrylate monomer (ETPTA, MW 428, viscosity 60 cps), however, may not be particularly limited so long as the resin is hardened under UV exposure. Also, in order to form a surface structure, silica was used as the colloidal particle. Although silica particles dispersed in ETPTA resin are present inside ETPTA droplets during droplet formation, the silica particles may move toward an interface of the droplets and form an arrangement to decrease interface energy. However, such available colloidal particles are not particularly limited to silica, but, may include any particles so long as the particles remain on the interface.

In order to ensure optical, electrical and/or magnetic functionality of microparticles, nanoparticles or a chemical substance were added to the photo-polymerisable resin, other than colloidal particles. Magnetic functionality was obtained by adding iron oxide nanoparticles while dye molecules were introduced for providing optical functionality. However, additional materials are not particularly limited thereto and may be any one if it can provide optical, electrical and/or magnetic functionality.

For microparticles, either droplets with regular or irregular size may be used. Uniform droplets are used for fabricating uniform-sized microparticles and are formed using a micro-fluidic device, although a method for formation of droplets is not particularly limited thereto if uniform droplets are obtained. On the other hand, non-uniform droplets are prepared using a shaker, a vortex mixer and/or a homogenizer, although a method for formation of droplets is not particularly limited thereto if non-uniform droplets are obtained. Preferably, a size of each droplet ranges from several micrometers to several millimeters.

As to photo-polymerization of droplets, UV curing is carried out by UV radiation using a mercury lamp at a light intensity of 40 mW/cm² for 0.1 to 10 seconds. However, combined conditions of light intensity and time are not particularly limited so long as photo-polymerization of droplets is successfully completed.

Embodiments of the present invention may further include an additional chemical process in order to modify a microfine structure formed using colloidal particles. For this purpose, using a silane coupling agent, chemical reaction was induced on an exposed surface of the colloidal particles in a continuous phase, thus patterning the same with dye molecules or hydrophobic molecules. Also, silver mirror reaction was selectively conducted on the exposed surface of the colloidal particles, in turn preparing microparticles with a patterned silver nano-structure. By removing colloidal particles present on the surface of microparticles, porous microparticles having holes formed on a surface thereof may be obtained. Such removal may be successfully attained using a sodium hydroxide solution or fluoric acid. Moreover, the porous microparticles are subjected to etching by a reactive ion etching process in order to increase porosity and modify a chemical surface structure thereof, thus enabling variation in surface characteristics. However, an additional chemical process is not particularly limited to the foregoing technologies, but may include any conventional chemical methods. Preferred embodiments of the present invention will be described by the following examples. However, such embodiments are provided for illustrative purposes but are not construed to restrict the scope of the present invention as defined by the appended claims.

### EXAMPLE 1

### Non Uniform-Sized Microparticles

An ETPTA monomer solution containing 5% (v/v) silica particles with a size of 200 nm dispersed therein was introduced into a surfactant, that is, 1 wt. % Pluronic F108 (ethylene oxide/propylene oxide/ethylene oxide triblock copolymer, BASF) dispersed in water. Using a vortex mixer, the mixture was formed into liquid drops. Then, further using a homogenizer, the obtained liquid drops were treated at 16,000 rpm for 30 seconds in order to prepare droplets. Such droplets were exposed to UV radiation at 40 mW/cm² for 5 seconds, thus curing the droplets into solids.

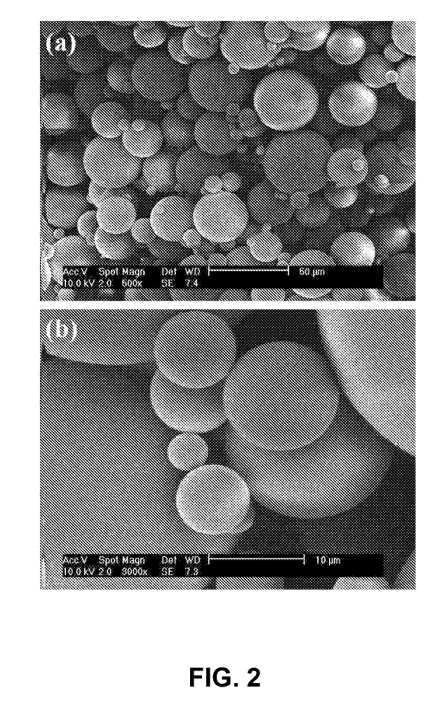

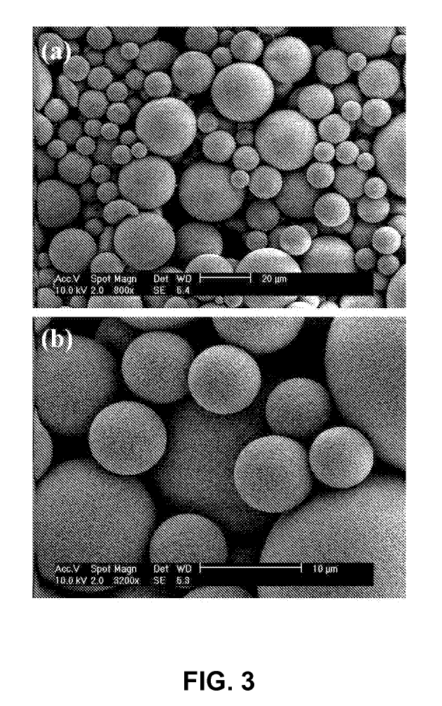

FIG. 3 is an SEM photograph illustrating microparticles formed according to the foregoing procedure. FIG. 3(b) shows the obtained microparticles having a surface structure formed of silica particles. FIG. 2 is an SEM photograph illustrating microparticles formed using an ETPTA monomer solution without dispersion of silica particles, according to the foregoing procedure. FIG. 2(b) shows a smooth surface of the formed microparticles.

Placing the microparticles having a surface structure formed of silica particles in 5% fluoric acid solution for 10 minutes, the silica particles present on the surface of the microparticles were removed.

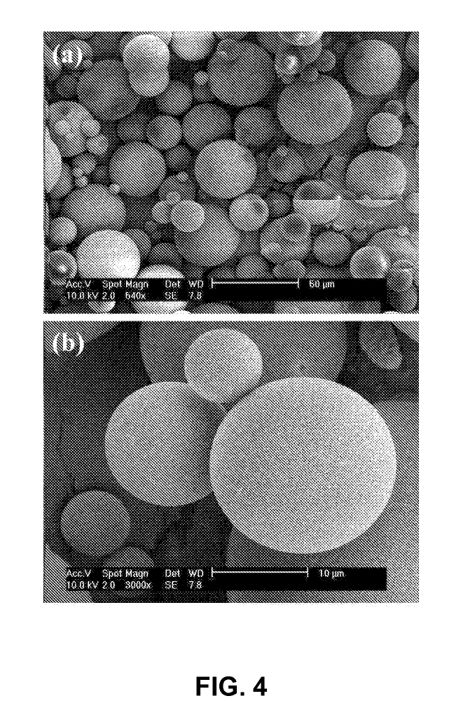

FIG. 4 is an SEM photograph illustrating porous microparticles having empty holes after removal of silica particles.

### EXAMPLE 2

### Uniform-Sized Microparticles

Using a silica-ETPTA monomer solution and a surfactant solution prepared by the same procedure as described in Example 1, uniform droplets were formed using a micro-fluidic device. 7.5 minutes after formation of the droplets, the same was exposed to UV radiation and photo-cured. As a result, microparticles having a regular size were obtained and a surface of the microparticles was formed with a hexagonal arrangement of silica particles.

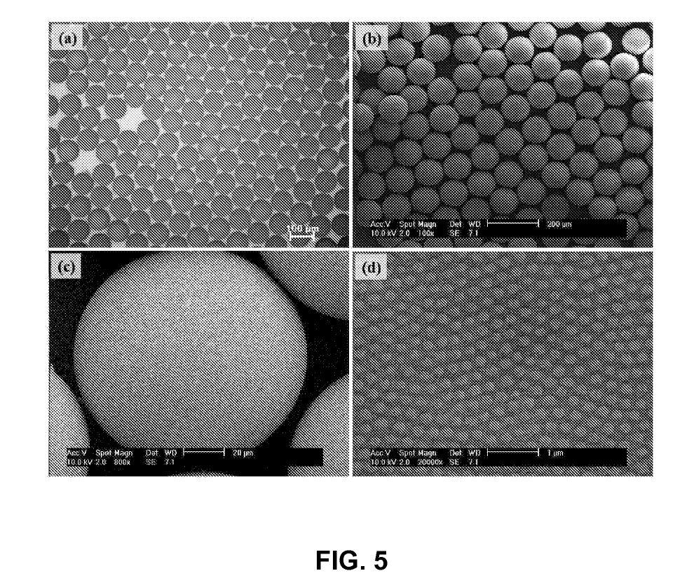

FIGS. 5(a) and 5(b) are an optical micrograph and SEM photograph illustrating uniform-sized microparticles. Moreover, FIG. 5(c) is an enlarged photograph of one microparticle while FIG. 5(d) is another SEM photograph showing a surface of the formed microparticles.

### EXAMPLE 3

### Microparticles Having a Surface Structure of Colloidal Particles with Different Sizes

Microparticles were formed by the same procedure as described in Example 2, except that a silica-ETPTA monomer solution was prepared by dispersing two or more types of silica particles having different sizes in an ETPTA monomer solution. Since the ETPTA solution containing 5% (v/v) of silica particles having a particle size of 200 nm and 5% (v/v) of silica particles having a particle size of 1 μm dispersed therein was used, microparticles having a specific surface structure formed of these particles having different sizes were produced. According to the same procedure as described in Example 1, these microparticles were kept in a 5% fluoric solution for 10 minutes in order to remove silica particles present on a surface of the microparticles, in turn resulting in porous microparticles having holes with different sizes.

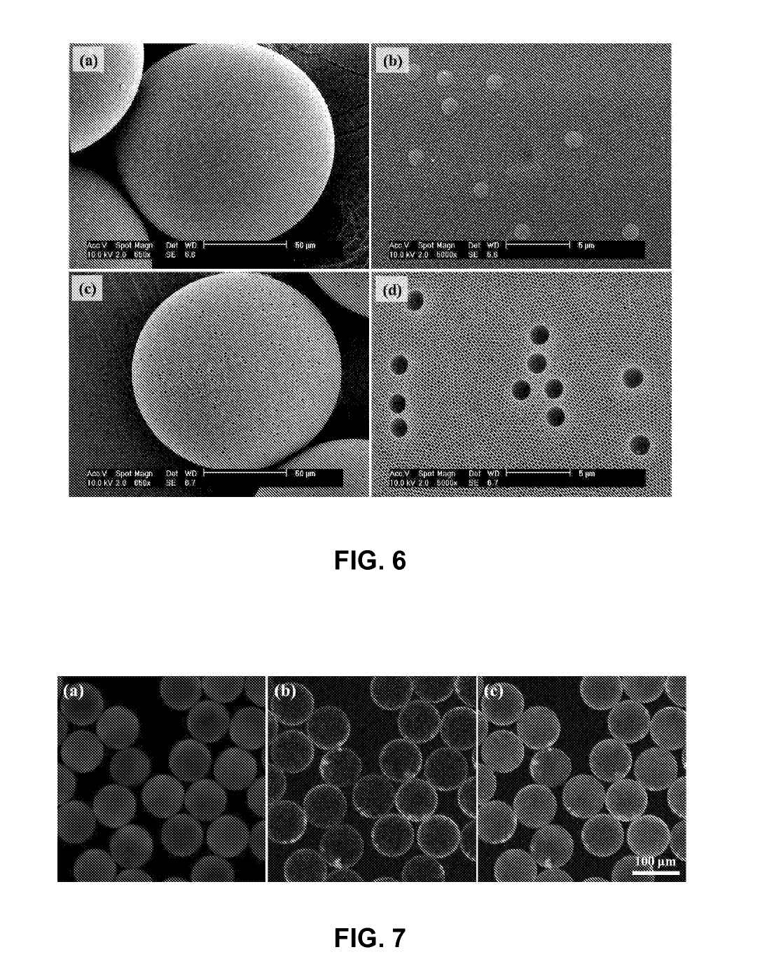

FIGS. 6(a) and 6(b) are SEM photographs illustrating microparticles having a surface structure formed of different-sized silica particles. Also, FIGS. 6(c) and 6(d) are SEM photographs illustrating microparticles having a surface structure of different-sized holes.

### EXAMPLE 4

### Microparticles Containing Dye Molecules

Microparticles were formed by the same procedure as described in Example 2, except that 10⁴ M rhodamine B isocyanate was additionally dispersed in a silica-ETPTA monomer solution. As a result, the obtained microparticles had a hexagonal arrangement of silica particles on a surface thereof, which is substantially identical to that obtained in Example 2, while containing dye molecules inside the microparticles. An exposed face of the silica particles present on the surface of the microparticles was subjected to chemical reaction using fluorescein isocyanate (FITC). For this purpose, FITC molecules were first chemically combined with 3-(aminopropyl)trimethoxysilane (APTMS). Then, adding a small amount of ammonia to microparticles dispersed in ethanol, the obtained mixture was admixed with an ethanol solution containing FITC-APTMS. Furthermore, tetraethoxysilane (TEOS: Aldrich) was added to the foregoing preparation, followed by conducting reaction for 2 days. As a result, it was found that FITC-APTMS molecules are bonded to a surface of silica particles only.

FIG. 7 is a confocal micrograph illustrating microparticles which contains rhodamine B isocyanate therein while having FITC on an exposed face of silica particles. It can be seen that the microparticles exhibit a fluorescent signal by rhodamine B isocyanate inside the microparticles, and emit another fluorescent signal by FITC on the surface thereof.

### EXAMPLE 5

### Microparticles Surface-Treated by Hydrophobic Chemical Substance

After microparticles having a surface structure formed of silica particles were prepared by the same procedure as described in Example 1, an exposed face of the silica particles was subjected to selective treatment using a hydrophobic chemical substance. For this purpose, the obtained microparticles were dispersed in ethanol, followed by adding a small amount of ammonia. Then, dropping 10 wt. % octadecyltrimethoxysilane (OTMOS) in chloroform into the mixture, reaction was conducted for 2 hours. As a result, a silanol group of the silica particle present on the surface of microparticles was substituted by OTMOS, thereby forminda hydrophobic surface of the microparticles.

### EXAMPLE 6

### Preparation of Microparticles Having Silver Nano-Structure Pattern

Using the microparticles having a regular size and a hexagonal arrangement of silica particles prepared in Example 2, a silver nano-structure was patterned on a surface of the microparticles. Silver mirror reaction was applied for the foregoing purpose. Firstly, a small amount of ammonia solution was added to 0.1 M aqueous silver nitrate solution to prepare Tollens reagent. Then, adding the microparticles to the prepared reagent, the mixture was admixed with 0.5 M glucose and 0.8 M aqueous potassium hydroxide solution, followed by conducting reaction for 3 minutes while gently shaking. As a result, such a silver nano-structure was selectively formed only on silica particles exposed from the surface of microparticles.

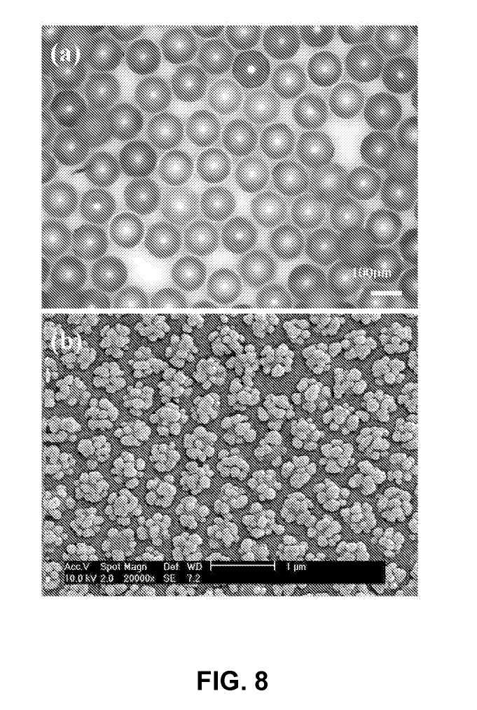

FIG. 8(a) is an optical micrograph illustrating the silver-decorated microparticles with a regular size, while FIG. 8(b) is an SEM photograph illustrating a silver nano-structure patterned in a hexagonal arrangement on the surface of the microparticles.

### EXAMPLE 7

### Microparticles Containing Iron Oxide Nanoparticles

Microparticles were formed by the same procedure as described in Example 2, except that 0.05% (v/v) haematite-iron oxide (α-Fe₂O₃) nanoparticles (with a particle size of less than 50 nm) were additionally dispersed in a silica-ETPTA monomer solution. As a result, the obtained microparticles had a hexagonal arrangement of silica particles on a surface thereof, which is similar to that of Example 2, while having haematite-iron oxide nanoparticles inside the microparticles. The prepared microparticles were influenced and moved by a magnet.

Alternatively, when the microparticles are prepared by additionally dispersing haematite-iron oxide nanoparticles to the foregoing monomer solution, droplets were placed in a magnetic field after forming the droplets and before UV exposure thereof, in order to align the haematite-iron oxide nanoparticles in a single direction then concentrate the same. Next, UV exposure was conducted to enable photo-curing of the droplets, thereby forming microparticles as a final product. Consequently, the obtained microparticles exhibited rapid response by the magnet.

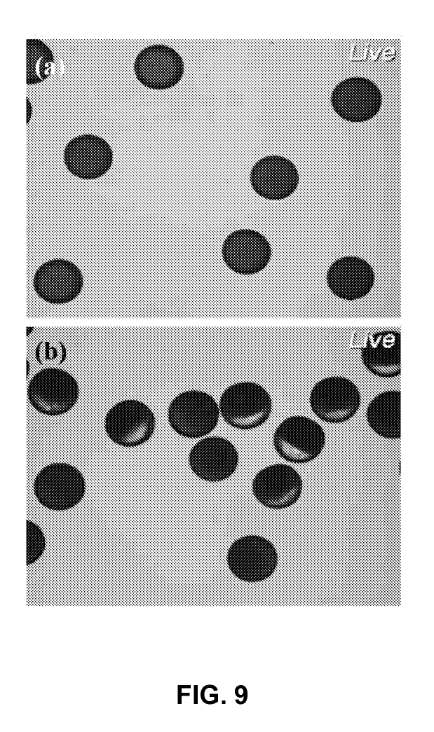

FIG. 9(a) is an optical micrograph illustrating microparticles containing iron oxide nanoparticles, while FIG. 9(b) is another optical micrograph illustrating microparticles containing iron oxide nanoparticles which are aligned and concentrated at one side of the microparticles.

### EXAMPLE 8

### Microparticles Having a Super-Hydrophobic Surface

After microparticles were prepared by the same procedure as described in Example 2, the prepared microparticles were treated using 5% fluoric solution for 10 minutes to form porous microparticles having a hexagonal arrangement of holes on a surface thereof. Then, the produced porous microparticles were subjected to reactive ion etching using SF₆ gas. As a result, porosity of a porous surface of the microparticles was considerably increased and fluorine molecules were generated on the porous surface. Consequently, the obtained porous microparticles had a super-hydrophobic surface thanks to the fluorine molecules present on the surface as well as enhanced porosity.

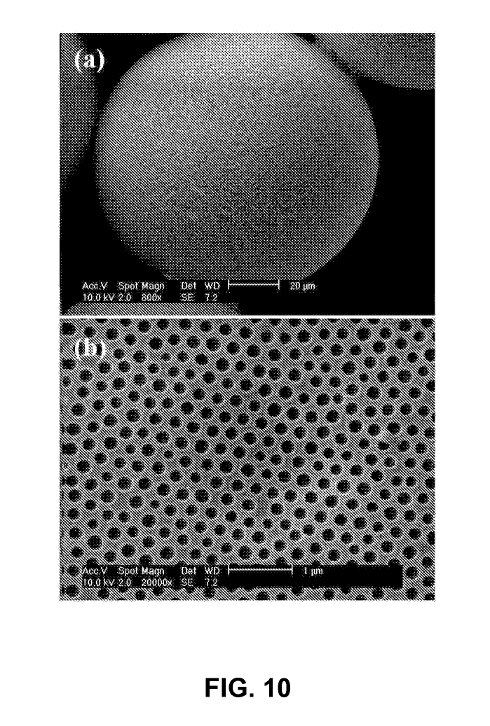

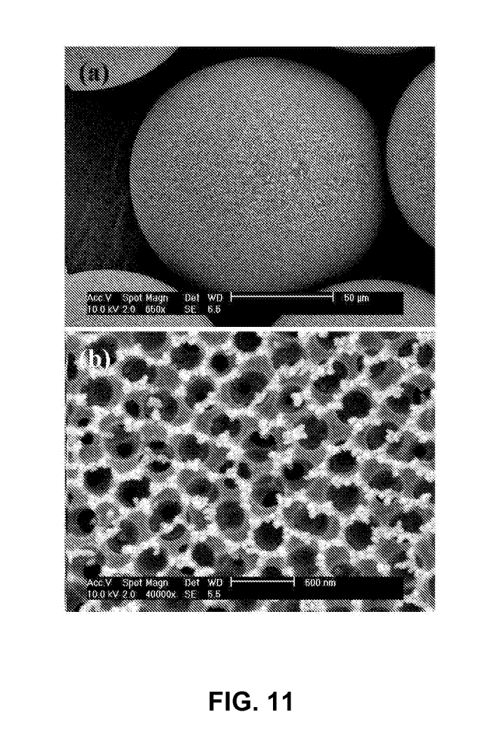

FIGS. 10(a) and 10(b) are SEM photographs illustrating mciroparticles having a hexagonal arrangement of holes formed after removal of silica particles, while FIGS. 11(a) and 11(b) are SEM photographs illustrating microparticles having a super-hydrophobic surface.

As is apparent from the foregoing description, a method for fabrication of microparticles as well as microparticles fabricated by the same according to the present invention may be employed in a wide range of industrial applications. Most of all, microparticles having protrusions formed on a surface thereof using colloidal particles have high fluidity, like a liquid. Especially, optical, electrical and/or magnetic functionality may be provided to the microparticles, in turn enabling utilization thereof in electronic paper. In addition, microparticles having a metal nano-structure such as Ag nano-structure may be used for high sensitivity chemical and/or bio-sensors based on surface enhanced Raman scattering phenomenon. Alternatively, microparticles having high porosity and containing a hydrophobic substance present on a surface thereof exhibit favorable super-hydrophobic surface characteristics, thereby being utilized as a principal material for forming a dew-condensation preventing surface. These are representative of direct applications of microparticles fabricated according to the present invention, although the present invention is not duly restricted thereto.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A method for fabrication of microparticles having a surface structure, the method comprising:
(a) preparing liquid droplets from photo-polymerizable resin containing colloidal particles dispersed therein; and
(b) conducting photo-polymerization of the prepared droplets to fabricate microparticles.

2. The method according to claim 1, wherein the colloidal particles are at least one selected from a group consisting of silica, titania and polystyrene.

3. The method according to claim 2, wherein the colloidal particles have a particle size of 10 to 10,000 nm and a fractional ratio of the colloidal particles ranges from 1 to 10% (v/v).

4. The method according to claim 2, wherein the photo-polymerizable resin is at least one selected from a monomer solution containing an acrylate, cyanoacrylate or epoxy group, or a monomer solution capable of generating a urethane group.

5. The method according to claim 1, further comprising additional dispersion of at least one selected from a group consisting of quantum dots, gold nanoparticles, silver nanoparticles and carbon black nanoparticles, to the photo-polymerizable resin.

6. The method according to claim 5, wherein a size of each nanoparticle ranges from 1 to 100 nm and a fractional ratio the nanoparticles ranges from 0.01 to 10% (v/v).

7. The method according to claim 1, further comprising additional dispersion of a chemical substance such as dye molecules or chemical pigments, to the photo-polymerizable resin.

8. The method according to claim 1, wherein a microfluidic device is used to form uniform-sized liquid droplets.

9. The method according to claim 1, wherein a shaker, a vortex mixer and a homogenizer are used to form liquid droplets.

10. The method according to claim 1, wherein a continuous phase comprises water or an organic solvent containing a surfactant.

11. The method according to claim 1, wherein the liquid droplets formed for complete photo-polymerization thereof are exposed to UV radiation.

12. A method for fabrication of microparticles having a surface structure, the method comprising:
(a) preparing liquid droplets from photo-polymerizable resin containing colloidal particles dispersed therein;
(b) conducting photo-polymerization of the prepared droplets to fabricate microparticles; and
(c) subjecting the fabricated microparticles to a further chemical process to improve the surface structure and characteristics thereof.

13. The method according to claim 12, wherein the colloidal particles present on a surface of the microparticles are chemically bonded with dye molecules or hydrophobic molecules by chemical reaction.

14. The method according to claim 12, wherein the colloidal particles present on a surface of the microparticles have a silver metal nano-structure formed by chemical reaction.

15. The method according to claim 12, wherein the colloidal particles present on a surface of the microparticles are selectively removed, thus fabricating porous microparticles having holes formed on a surface thereof.

16. The method according to claim 15, wherein the colloidal particles are removed using a fluoric solution, a sodium hydroxide solution or toluene.

17. The method according to claim 12, wherein the surface structure of the microparticles fabricated using colloidal particles on a surface thereof is modified by reactive ion etching.

18. The method according to claim 15, wherein the surface structure of the porous microparticles is modified by reactive ion etching.

19. The method according to claim 12, wherein a dye or synthetic coloring agent is applied to a surface of the microparticles or inside the liquid droplets.

20. The method according to claim 19, wherein the dye or synthetic coloring agent is at least one selected from a group consisting of rhodamine, fluorescein, coumarin based dyes or food dyes.
